(19) United States
(12) Patent Application Publication
(10) Pub. No.: US 2005/0080514 A1
(43) Pub. Date: Apr. 14, 2005

(54) Content providing system

(75) Inventors: Masanori Omote, Kanagawa (JP); Kazumi Aoyama, Saitama (JP); Tsuyoshi Takagi, Saitama (JP); Masahiro Fujita, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/921,208

(22) Filed: Aug. 19, 2004

(30) Foreign Application Priority Data
Sep. 1, 2003 (JP) 2003-309279

(51) Int. Cl. G06F 19/00

(52) U.S. Cl. 700/253; 700/245

(57) ABSTRACT

In requesting content, a robot transmits a QA form containing robot information, such as the hardware configuration of the robot, to a server. The server detects the content adapted to the hardware configuration or platform of the robot in the QA form, and provides the detected content to the robot.

### BACKGROUND OF THE INVENTION

1. Field of the Invention

The present invention generally relates to content providing systems, and particularly to a content providing system for providing content adapted to functions of a robot.

2. Description of the Related Art

A mechanical apparatus which utilizes electric or magnetic actions to perform motions which resemble motions of human beings is referred to as a “robot.” It is said that the word robot is etymologically derived from the Slavic word “ROBOTA (slave machine).” In Japan, robots have become widespread since the end of 1960s, but most of them have been manipulators for the purpose of automated or unmanned production operations at factory or industrial robots such as conveyor robots.

One use of robots is to take on various difficult tasks in industrial activities, production activities, etc. For example, dangerous jobs or difficult jobs such as maintenance jobs in nuclear power plants, thermal power plants, or petrochemical plants, part conveying and assembling jobs at manufacturing factory, cleaning of tall buildings, and rescues at fires or other sites are taken on.

Other uses of robots include living uses, i.e., “coexistent” uses with human beings or “entertainment” uses rather than the job supporting uses described above. Robots of this type emulate a variety of emotional expressions using the motion mechanisms or the extremities of human beings or relatively intelligent legged walking animals such as dogs (pets) and bears. Not only are pre-entered motion patterns strictly performed, but vivid expressions which dynamically respond to words or attributes, such as “praise,” “scolding,” “hitting,” etc., received from a user or any other robot are also demanded.

Recently, a variety of mobile robots have been commercially available, including two-legged walking robots, four-legged walking robots, and wheeled robots.

A variety of types of content are required for activating a robot, such as motion data that describes motions of the robot and application programs for performing behavior control according to external stimuli or internal states. However, due to the limited memory capacity of the robot, it is difficult to pre-install all required content in the robot. Moreover, it may be necessary to install software after shipment each time the software is updated or a new product is sold.

Therefore, a mechanism for providing content to a robot by, for example, downloading new content from a server on a network to the robot has been demanded.

In the related art, a mechanism for providing content adapted to the type of robot and the hardware configuration or platform of the robot has not been developed, and the desired content may not be provided to the robot.

### SUMMARY OF THE INVENTION

Accordingly, it is an object of the present invention to provide a content providing system for providing content to a robot in accordance with the hardware configuration or platform of the robot.

In a first aspect of the present invention, a content providing system includes a robot and a server. The robot includes a requesting unit that transmits robot information to a server to request the server to provide content, and a using unit that uses the content provided in accordance with the request of the requesting unit. The server includes a detecting unit that detects content having usage conditions that are met by the robot information, and a providing unit that provides the content detected by the detecting unit to the robot.

The robot information may include information about an operating system of the robot, a unique robot ID assigned to the robot, a robot-type ID assigned to the type of the robot, hardware configuration information of the robot, a function list of the robot, a database list of the robot, or work environment information of the robot.

The usage conditions may include information about an operating system required for using the content, a unique robot ID assigned to a robot that is permitted to use the content, an ID indicating the type of a robot that is permitted to use the content, a function list required or recommended for using the content, information about a robot configuration required or recommended for using the content, or information about a work environment required for recommended for using the content.

In the content providing system according to the first aspect of the present invention, therefore, the robot transmits robot information to the server, requests the server to provide required content, and uses the content provided in accordance with the request. The server detects content having usage conditions that are met by the robot information, and provides the detected content to the robot.

In a second aspect of the present invention, a content providing system includes a robot and a server. The server includes a transmitting unit that transmits to the robot usage conditions of content that the server can provide, and a providing unit that provides content whose usage conditions are satisfied by the robot to the robot. The robot includes a requesting unit that determines whether or not the robot satisfies the usage conditions transmitted by the transmitting unit of the server and that requests the server to provide content whose usage conditions are satisfied by the robot.

In the content providing system according to the second aspect of the present invention, therefore, the server transmits to the robot usage conditions of content that the server can provide, and provides the content whose usage conditions are satisfied by the robot to the robot. The robot determines whether or not the robot satisfies the usage conditions transmitted by the server, and requests the server to provide the content whose usage conditions are satisfied by the robot.

According to the content providing system of the present invention, therefore, content adapted to each robot can be provided.

### BRIEF DESCRIPTION OF THE DRAWINGS

FIG. 1 is a diagram showing the overall structure of a content providing system according to the present invention;

FIG. 2 is a diagram showing the overview of a content requesting method;

FIG. 3 is a block diagram of a robot shown in FIG. 1;

FIG. 4 is a block diagram of a control unit shown in FIG. 3;

FIG. 5 is a diagram showing a program to be executed by a CPU shown in FIG. 3;

FIG. 6 is a block diagram of a server shown in FIG. 1;

FIG. 7 is a diagram showing the content of a database stored in an HDD shown in FIG. 6;

FIG. 8 is a sequence diagram showing the operation of the robot and the server shown in FIG. 1;

FIG. 9 is a description of a QA form;

FIG. 10 is a description of the QA form;

FIG. 11 is a description of the QA form;

FIG. 12 is a description that defines usage conditions of content;

FIG. 13 is a diagram showing nodes detected from the QA form; and

FIG. 14 is a description of a request for content.

### DESCRIPTION OF THE PREFERRED EMBODIMENTS

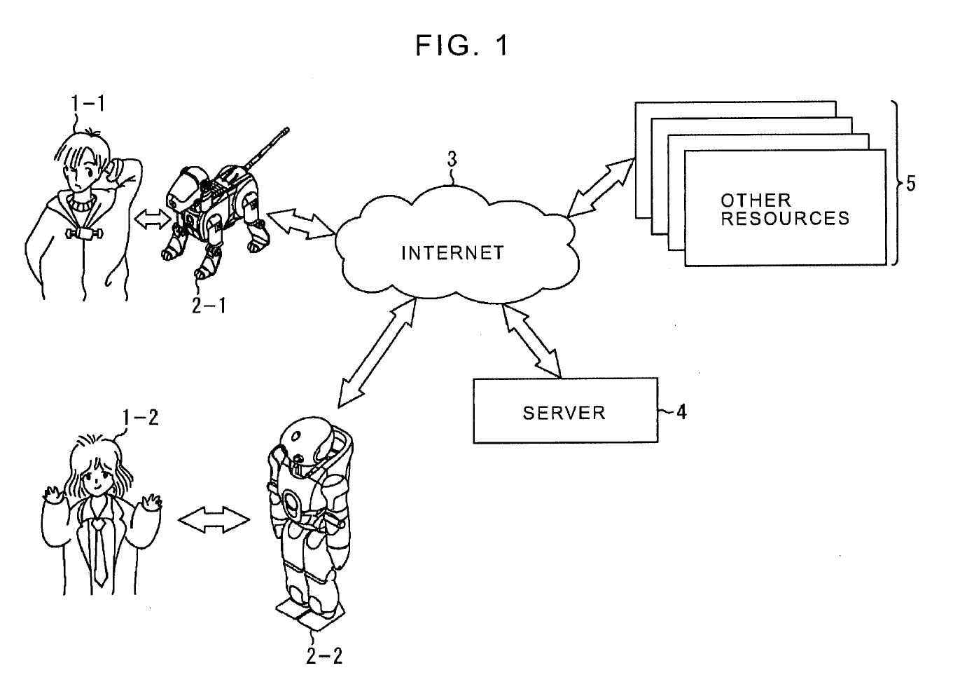

FIG. 1 is a configuration diagram of a content providing system according to the present invention.

A user 1-1 interacts with a dog-type robot 2-1, and a user 1-2 interacts with a human-type robot 2-2. In the following description, the users 1-1 and 1-2 and the robots 2-1 and 2-2 are generally referred to as a user 1 and a robot 2, respectively, if the users 1-1 and 1-2 and the robots 2-1 and 2-2 need not be individually identified. The same applies to other components.

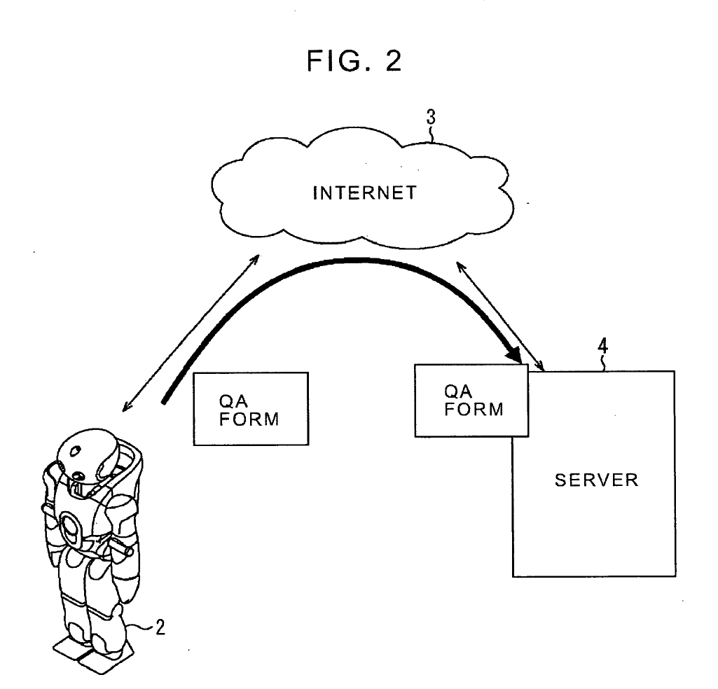

The robot 2 performs an action requested by the user 1. The robot 2 is connected to the Internet 3 wirelessly or via line. If the robot 2 does not have data or programs required for performing an action requested by the user 1, such as motion data for a dance sequence or various applications or middleware (such data or programs are hereinafter collectively referred to as “content”), as shown in FIG. 2, the robot 2 requests a server 4 to provide the content using a QA form described below. Then, the robot 2 acquires the content adapted to the manufacturer of the robot 2, the hardware configuration or platform of the robot 2, etc., and performs the action requested by the user 1.

The server 4 manages content to be provided to the user 1 via the robot 2. In response to the QA-form request from the robot 2, the server 4 provides content adapted to the manufacturer of the robot 2, the hardware configuration or platform of the robot 2, etc., to the robot 2.

The server 4 may divide content to be provided to the robot 2 into a plurality of sites 5 not in a single site, and may provide a Web service to introduce a different site that associates the sites.

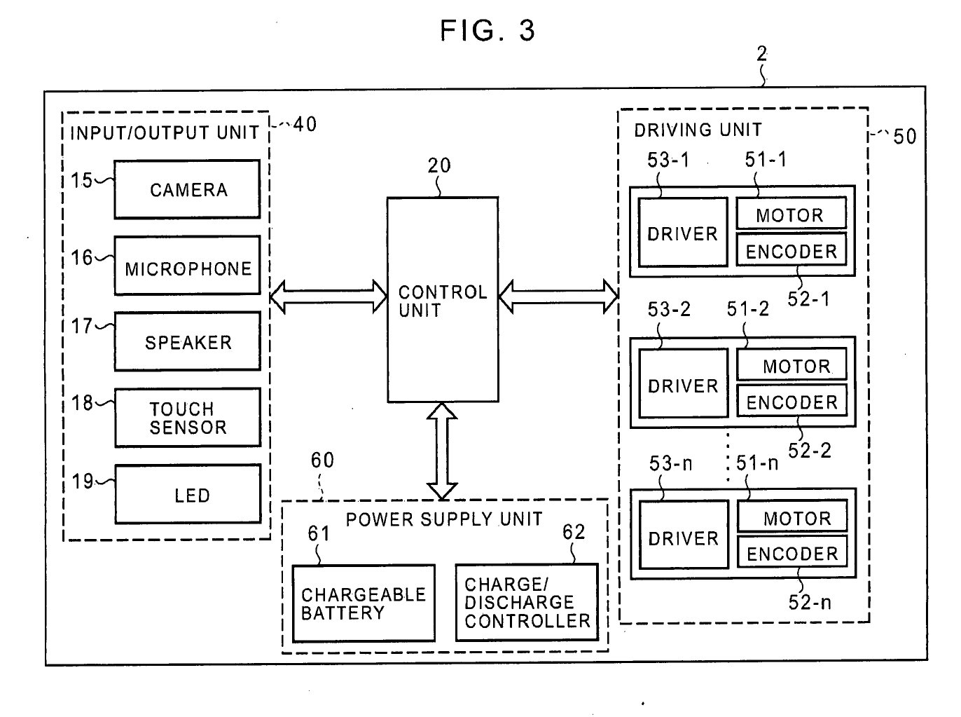

FIG. 3 is a block diagram of the robot 2.

An input/output unit 40 has input units including sensors corresponding to the five human senses, such as a charge-coupled device (CCD) camera 15 disposed at the eye of the robot 2, a microphone 16 disposed at the ear of the robot 2, and a touch sensor 18 disposed at the head or back of the robot 2 for sensing a touch of the user 1.

The input/output unit 40 also has output units including a speaker 17 disposed at the mouth of the robot 2, and a light emitting diode (LED) indicator (eye lamp) 19 that gives facial expressions by turning on and off the LED indicator 19 or by turning on the LED indicator 19 at a certain timing. The output units output audio and turn on and off the lamp, thus allowing a user feedback from the robot 2 to be expressed in form other than mechanical motion patterns using legs, etc.

A driving unit 50 is a functional block that realizes motions of the robot 2 according to a predetermined motion pattern instructed by a control unit 20, and is controlled by behavior control. The driving unit 50 is a functional module that realizes flexible articulated motions of the robot 2, and a plurality of drive units are individually provided for the articulation axes of movements of the articulation joints of the robot 2, such as a roll, a pitch, and a yaw. Each drive unit includes a motor 51 that rotates on a predetermined axis, an encoder 52 that detects the rotational position of the motor 51, and a driver 53 that adaptively controls the rotational position or rotational speed of the motor 51 based on an output of the encoder 52.

The combination of the drive units determines the hardware configuration of the robot 2. For example, the robot 2-2 is configured as a two-legged walking mobile robot, and the robot 2-1 is configured as a four-legged walking mobile robot.

A power supply unit 60 is a functional module that supplies power to electric circuits in the robot 2. The robot 2 is a self-driven robot using a battery, and the power supply unit 60 includes a chargeable battery 61 and a charge/discharge controller 62 that manages the charged/discharged state of the chargeable battery 61.

The chargeable battery 61 is in form of, for example, a “battery pack” having a plurality of lithium-ion secondary battery cell packaged in a cartridge.

The charge/discharge controller 62 determines the remaining life of the battery 61 by measuring a terminal voltage and the amount of charging/discharging current of the battery 61, the ambient temperature of the battery 61, etc., and determines the charging start time and the charging stop time. The charging start time and the charging stop time, determined by the charge/discharge controller 62, are sent to the control unit 20, and triggers the robot 2 to start and stop a charging operation.

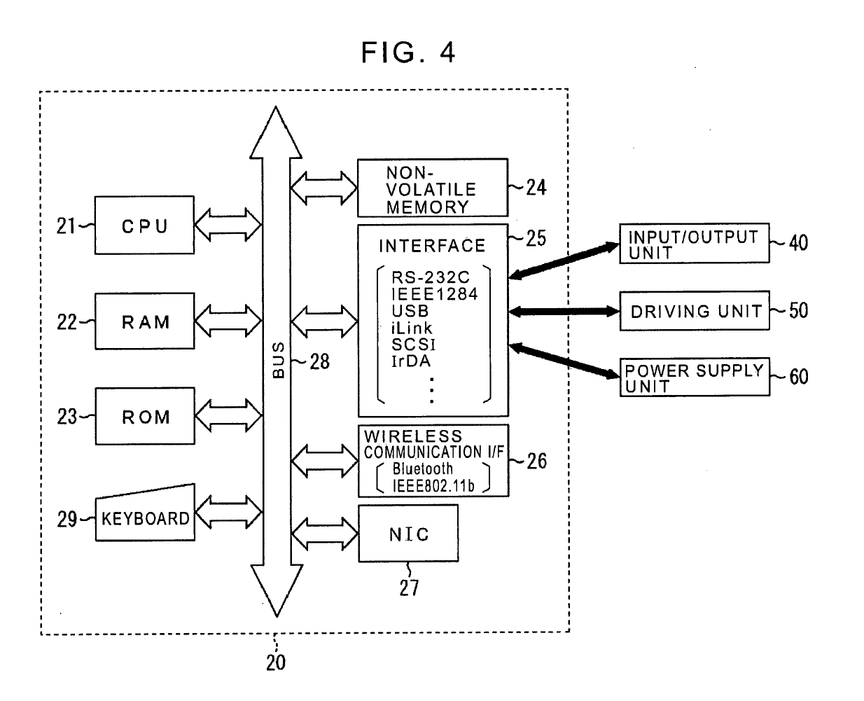

The control unit 20 serves as a “brain”, and is disposed at, for example, the head of body of the robot 2. The configuration of the control unit 20 is shown in FIG. 4.

A central processing unit (CPU) 21 serving as a main controller is connected to memories or other circuit components and to peripheral devices via a bus 28. The bus 28 is a common signal transmission path including a data bus, an address bus, a control bus, and so on. Each device on the bus 28 is assigned a unique address (memory address or I/O address). The CPU 21 designates an address to communicate with a specific device on the bus 28.

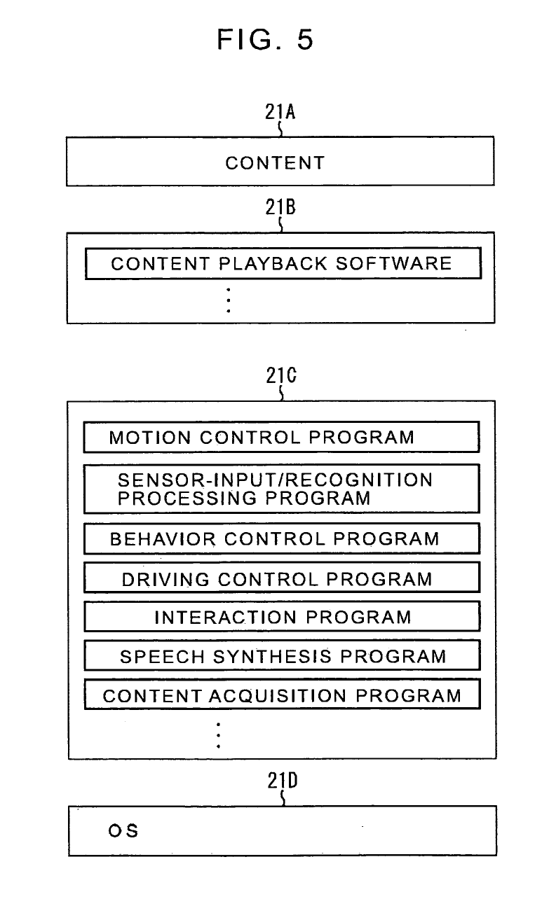

Referring to FIG. 5, the CPU 21 executes various application programs 21B, such as playback software for playing back content 21A, and various types of middleware 21C under the control of an operating system (OS) 21D.

The middleware 21C includes a self-diagnostic test program, a motion control program, a sensor-input/recognition processing program, a behavior control program, a driving control program, an interaction program, a speech synthesis program (or a text-to-speech (TTS) program), a content acquisition program, and so on. The self-diagnostic test program is executed when the robot 2 is powered on. The motion control program defines motions of the robot 2. The sensor-input/recognition processing program processes sensor inputs from the camera 15, the microphone 16, etc., to recognize external stimuli as symbols. The behavior control program controls the behavior of the robot 2 based on the sensor inputs and predetermined behavior control models while controlling memory operations such as a short-term memory operation or a long-term memory operation. The driving control program controls the driving operations of the articulation motors and the audio output of the speaker 17 according to the behavior control models. The interaction program allows interaction with the user 1. The content acquisition program is used to access the server 4 via a network to acquire the content requested by the user 1.

The combination of the hardware configuration of the robot 2 and the operating system 21D determines the platform of the robot 2, and the platform determines the middleware 21C executable on the robot 2. Depending upon the middleware 21C installed, the application program 21B and the content 21A can or cannot be executed or played back on the robot 2.

In this example, the robot 2 is connected to a network to download content in streaming or other format from the server 4 on the Internet 3. The content acquisition program in the middleware 21C has the following functions:
a wireless local area network (LAN) for establishing connection to the network;
a SOAP (Simple Object Access Protocol)/XML module for combining information into a SOAP envelope and extracting the received information;
an HTTP (Hyper Text Transfer Protocol) module for communicating SOAP envelopes via HTTP;
a software module for administrating communication;
an audio input/output module for interaction with the user;
a module for matching descriptions using the XML module; and
a module for resolving the dependency using the description matching.

Referring back to FIG. 4, a random access memory (RAM) 22 is a writable memory formed of a volatile memory, such as a dynamic RAM (DRAM). The RAM 22 loads the above-described program code to be executed by the CPU 21, and temporarily stores work data of an execution program.

A read-only memory (ROM) 23 persistently stores various programs to be executed by the CPU 21 and data.

A non-volatile memory 24 is formed of, for example, an electrically erasable and rewritable memory device such as an electrically erasable and programmable ROM (EEPROM). The non-volatile memory 24 stores, in a non-volatile manner, data to be sequentially updated. The data to be sequentially updated includes an encryption key and other security information, a device control program to be installed after shipment, and so on.

The data to be sequentially updated also includes robot information as follows:
OS information;
a unique robot ID uniquely assigned to the robot;
a robot-type ID uniquely assigned to the type of robot;
hardware configuration information of the robot;
a function list of the robot; and
a database list of the robot.

The OS information represents device-independent module information, including the type and version of the operating system 21D.

The hardware configuration information of the robot represents information, including the physical configuration of the robot (such as a human-type robot, a four-legged pet robot, a utility robot, or a wheeled robot), the number of legs (such as two legs or four legs), the maximum moving speed, the number of hands, the hand portability, other physical characteristics of the robot housing, the index of intelligence (computation), and so on.

The function list of the robot includes information indicating, for example, the name, version, and functions (e.g., up to how many kilograms can be lifted by the robot 2, the moving speed of the robot 2, the required CPU, information indicating whether the middleware 21C must reside in the robot 2 or can run on an external unit, etc.) of the middleware 21C that is currently installed in the robot 2.

An interface 25 establishes mutual connection between the control unit 20 and an external device to exchange data. The interface 25 inputs and outputs data to and from the input/output unit 40, e.g., the camera 15, the microphone 16, and the speaker 17. The interface 25 also inputs and outputs data or commands to and from the drivers 53 in the driving unit 50.

The interface 25 includes a serial interface such as an RS (Recommended Standard)-232C interface, a parallel interface such as an IEEE (Institute of Electrical and electronics Engineers) 1284 interface, general-purpose interfaces for establishing connection to computer peripheral devices, such as a USB (Universal Serial Bus) interface, an i-Link (IEEE 1394) interface, a SCSI (Small Computer System Interface), and a memory card interface (card slot) for receiving a PC card or a memory stick. The interface 25 may transfer programs and data to and from an external device (server)-that is locally connected or connected via the Internet.

Alternatively, the interface 25 may include an infrared communication (IrDA) interface to perform wireless communication with an external device.

A wireless communication interface 26 performs data communication with, for example, a host computer (not shown) via short-range wireless data communication technology, such as Bluetooth™, or via a wireless network, such as IEEE 802.11b.

A network interface card (NIC) 27 performs data communication with the server 4 over a wide area network such as the Internet 3.

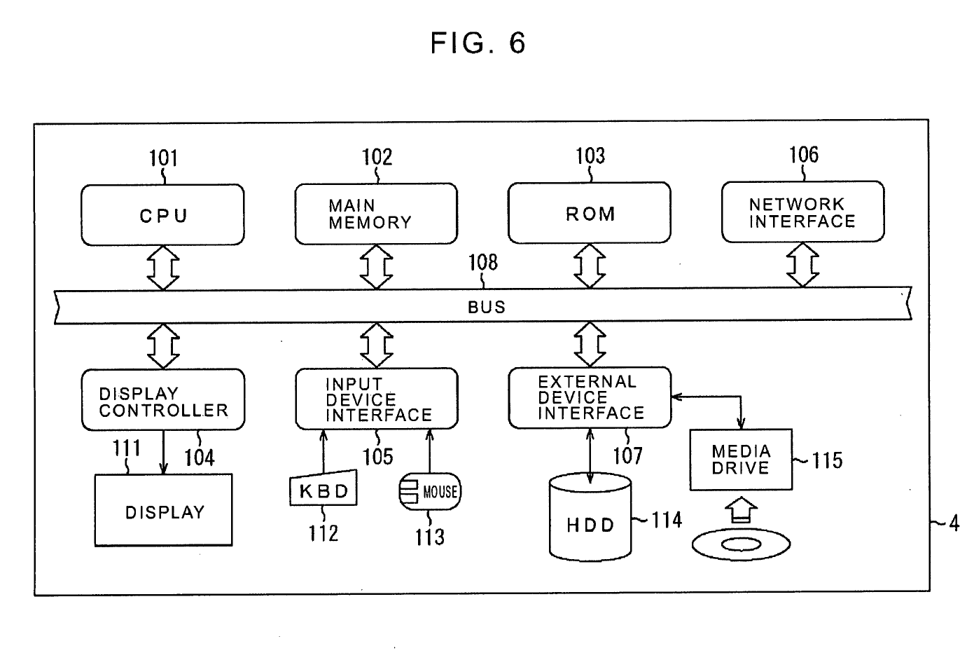

FIG. 6 is a block diagram of the server 4.

A CPU 101 serving as a main controller is connected with other devices (described below) via a bus 108, and executes various applications under the control of an operating system (OS).

The CPU 101 executes software programs, such as a server program for operating as an HTTP server on the Internet 3, an interface agent for analyzing a request from the user 1, a content manager for providing the data or program adapted to the hardware configuration or platform of the requesting robot 2 in accordance with a request of the user 1.

In order to provide content adapted to the hardware configuration or platform of the requesting robot 2 in accordance with a request of the user 1 to the robot 2 via a network, the CPU 101 further includes the following elements:
a SOAP/XML module for combining information into a SOAP envelope and extracting the received information;
an HTTP module for communicating SOAP envelopes via HTTP;
a hardware module for performing network communication;
a module for matching capability descriptions;
a name server module for a dynamic domain name server (DNS) that lists robots that currently participate in the network;
a module for matching descriptions using the XML module;
a module for resolving the dependency using the description matching; and
downloadable content registered together with a description.

SOAP is an XML- or HTTP-based protocol for a server on a system to call data and services located in another system. In SOAP communication, a message (or an envelope) in which additional information is appended to an XML document is exchanged via a protocol such as HTTP. Both a client and a server have an engine for generating and interpreting a SOAP message, thus allowing an object to be called in different environments.

A main memory 102 is a storage device used to load program code to be executed by the CPU 101 and to temporarily store work data of an execution program. The main memory 102 is, for example, a semiconductor memory such as a DRAM.

A ROM 103 is a semiconductor memory for persistently storing data. The ROM 103 contains, for example, a power-on self test (POST) that is a self-diagnostic test when the power is turned on, basic input/output system (BIOS) that is program code for controlling hardware input/output, and so on.

A display controller 104 is a dedicated controller for actually processing drawing instructions issued by the CPU 101. The drawing data processed by the display controller 104 is written in, for example, a frame buffer (not shown), and is then output on a display 111.

An input device interface 105 connects user input devices, such as a keyboard 112 and a mouse 113, to the CPU 101. The data, commands, etc., entered by the user are input to the system using the keyboard 112 and the mouse 113.

A network interface 106 connects the server 4 to a local network such as a LAN and to a wide area network such as the Internet 3 via a predetermined communication protocol such as Ethernet®.

An external device interface 107 connects an external device, such as a hard disk drive (HDD) 114 or a media drive 115, to the CPU 101.

The HDD 114 is an external storage device having a magnetic disk as a storage medium fixedly mounted therein.

The HDD 114 stores software programs including an operating system to be executed by the CPU 101, an application program, a device driver, a server program, an interface agent, a content manager, and so on.

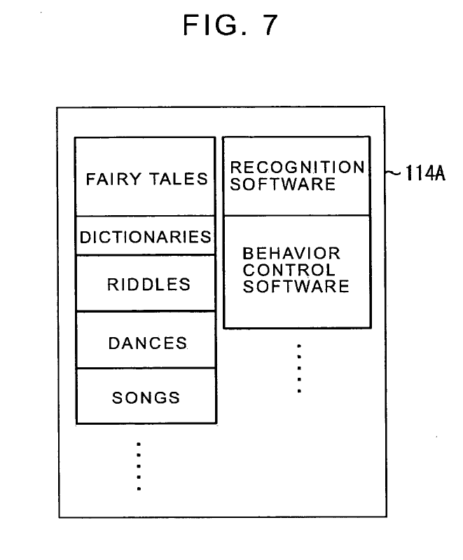

The HDD 14 includes a content database 114A shown in FIG. 7, containing a variety of data and programs. The content database 114A includes data content such as fairy tales, dictionaries, and riddles, applications such as dances and songs, middleware such as recognition software, robot behavior control software, and so on.

The content has content information and content usage-condition information.

The content information includes the following meta-information:

<ContentsType>News</ContentsType>
<ContentsType>DanceMotion</ContentsType> representing

content type information;

<DataType>Text</DataType>
<DataType>MIDI</DataType> representing data type

information;

<CreateDate>2003/03/23</CreateDate> representing

creation date information; and

<Title>WeAreSDR</Title> representing title

information.

The content usage-condition information includes the following information:
information about an OS required for using the content;
a unique robot ID of a robot that is permitted to use the content;
a robot-type ID of a robot that is permitted to use the content;
information about robot hardware configuration required or recommended for using the content;
a function list required or recommended for using the content;
data required for using the content; and
information about a work environment required or recommended for using the content.

The function list required or recommended for using the content includes a list of middleware required for using and playing back the content.

The information of robot hardware configuration required or recommended for using the content represents information, including the physical configuration of the robot 2 (such as a human-type robot, a four-legged pet robot, a utility robot, or a wheeled robot), the number of legs (such as two legs or four legs), the maximum moving speed, the number of hands, the hand portability, other physical characteristics of the robot housing, the index of intelligence (computation), and so on.

The information about a work environment required or recommended for using the content includes optimum or recommended index values of emotions, such as the feeling and instinct, of the robot 2, and optimum or recommended index values of external stimuli, such as the temperature of the robot housing (i.e., the temperature of external parts or internal parts of the robot 2, such as an actuator), the humidity, the amount of light, the illuminance, the amount of solar radiation, the duration of solar radiation, the sound pressure level, the intensity of radio field including wireless LAN, the floor or road type, and the acceleration. In a system using a combination of the robot 2 and an external processor, middleware conditions as to whether the middleware must reside in the robot 2, whether the middleware may be removed later, whether the middleware may run on the external processor, etc., are also contained.

When a portable medium such as a compact disc (CD), a magneto-optical (MO) disc, or a digital versatile disc (DVD) is loaded, the media drive 115 accesses the data recording surface of the media.

Portable media are mainly used to back up software programs and data files in a computer-readable manner or to transfer (i.e., sell, distribute, deliver, etc.) the programs and files between systems.

Some of the data content and programs depend upon the execution environment, such as the hardware configuration or platform, of the robot 2, and others do not, when such data content and programs are played back and executed.

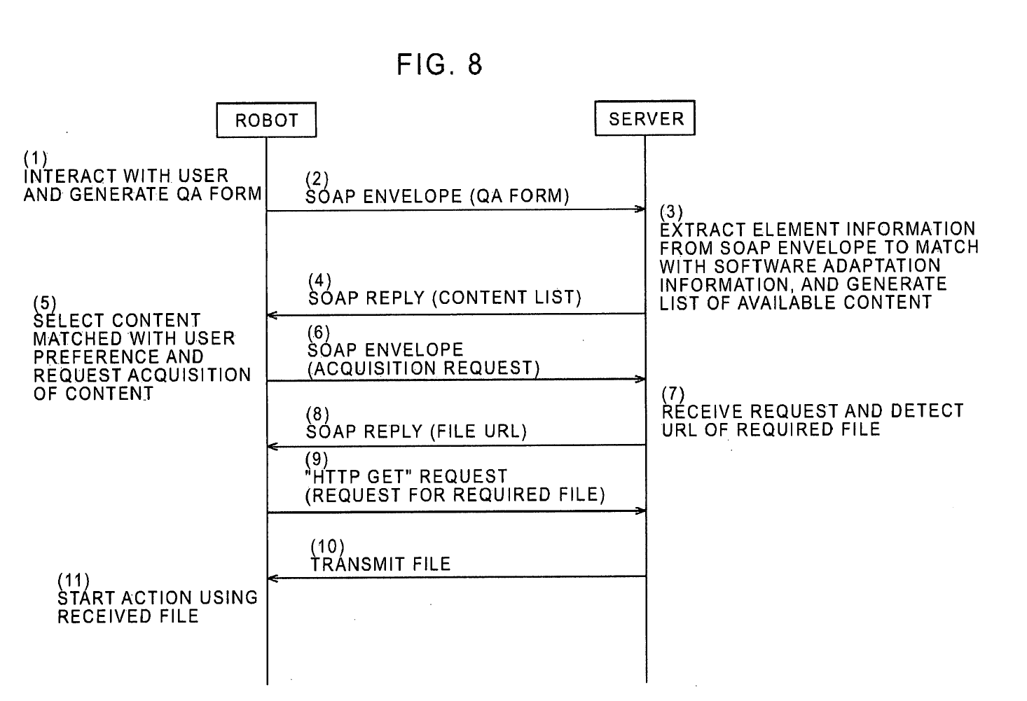

FIG. 8 is a sequence diagram showing the operation of the robot 2 and the server 4.

The user 1 interacts with the robot 2. If the robot 2 does not have content for performing an action requested by the user 1, the robot 2 generates a QA form for requesting the content (step (1)).

The QA form includes, for example, robot information and content information. If the information is stored in the non-volatile memory 24, the stored information is used; otherwise, the information is acquired, if necessary.

For example, the robot information includes the following information:
OS information;
a robot ID uniquely assigned to the robot;
a robot-type ID uniquely assigned to the type of robot;
hardware configuration information of the robot;
a function list of the robot;
a database list of the robot; and
work environment information.

The OS information represents device-independent module information, including the type and version of the operating system 21D.

The hardware configuration information of the robot represents information, including the physical configuration of the robot (such as a human-type robot, a four-legged pet robot, a utility robot, or a wheeled robot), the number of legs (such as two legs or four legs), the maximum moving speed, the number of hands, the hand portability, other physical characteristics of the robot housing, the index of intelligence (computation), and so on.

The function list of the robot includes information indicating, for example, the name, version, and functions (e.g., up to how many kilograms can be lifted by the robot 2, the moving speed of the robot 2, the required CPU, information indicating whether the middleware must reside in the robot 2 or can run on an external unit, etc.) of the middleware that is currently installed in the robot 2.

The work environment information includes optimum or recommended index values of emotions, such as the feeling and instinct, of the robot 2, and optimum or recommended index values of external stimuli, such as the temperature of the robot housing (i.e., the temperature of external parts or internal parts of the robot 2, such as an actuator), the humidity, the amount of light, the illuminance, the amount of solar radiation, the duration of solar radiation, the sound pressure level, the intensity of radio field including wireless LAN, the floor or road type, and the acceleration.

The content information includes the content of interaction with the user 1.

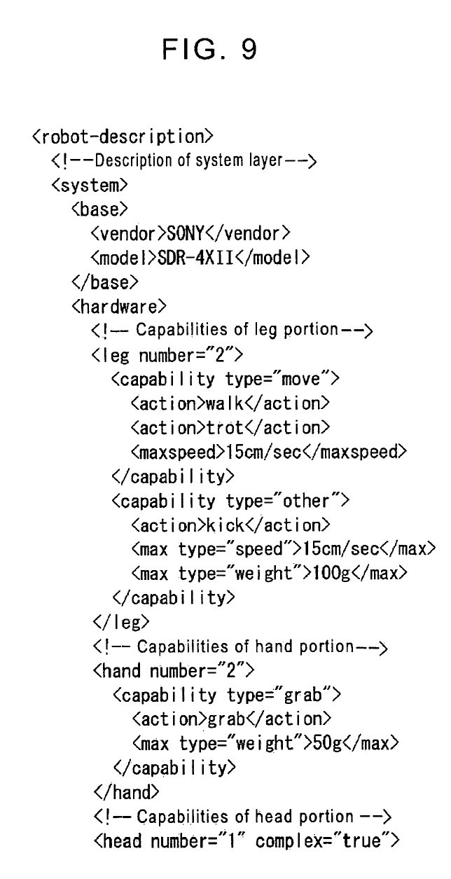

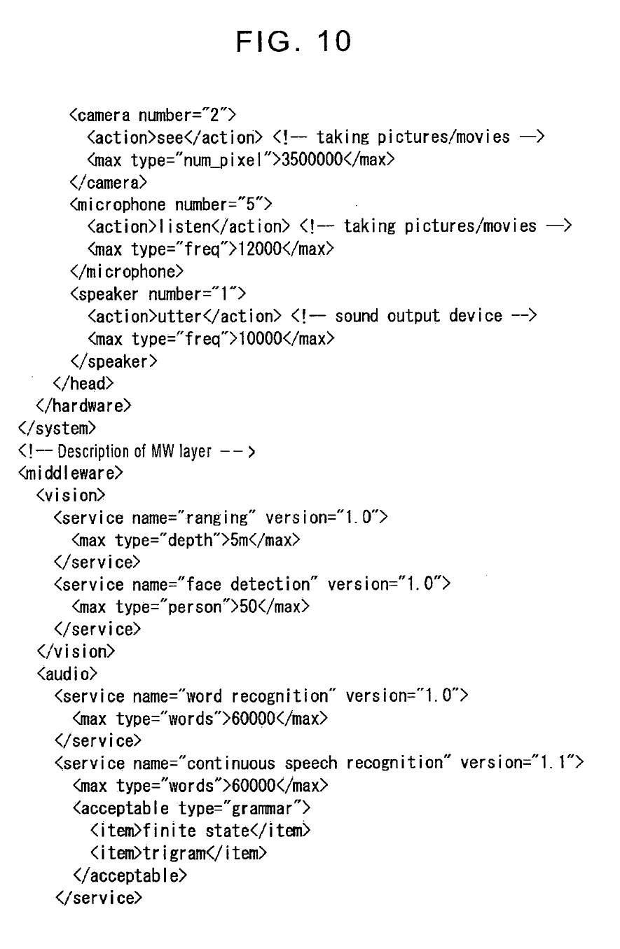

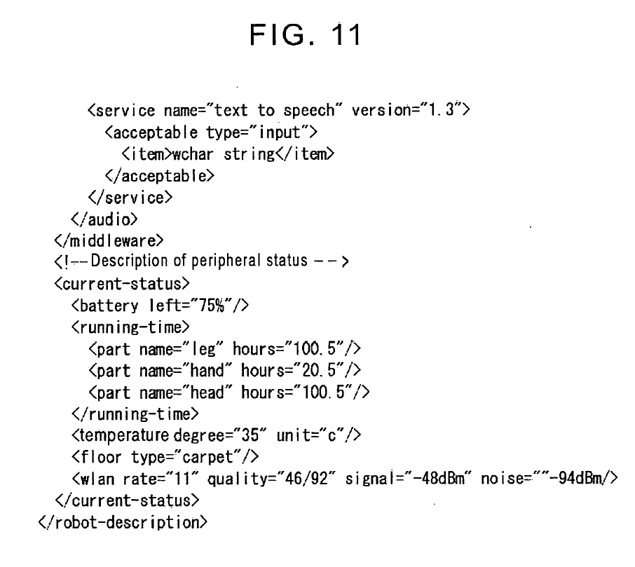

FIGS. 9 to 11 constitute a single description of the QA form. The description shown in FIGS. 9 to 11 has a hierarchical structure, and the relationship of the description is determined merely considering the relationship between adjacent layers. The description further provides a framework for resolving the dependency of content and hardware.

Referring back to FIG. 8, the robot 2 combines the generated QA form into a SOAP envelope, and transmits the SOAP envelope to the server 4 via HTTP (step (2)).

The server 4 analyzes the SOAP envelope transmitted from the robot 2, and extracts element information (i.e., the robot information and the content information) from the QA form. The server 4 further matches the extracted information with the additional information in the content database 114A.

More specifically, the additional content information, i.e., the content usage-condition information, is matched with the robot information and content information described in the QA form.

Based on a matching result, the server 4 selects the content adapted to the hardware configuration or platform of the requesting robot 2 in accordance with the request of the user 1, and generates a list of content that the server 4 can provide (step (3)).

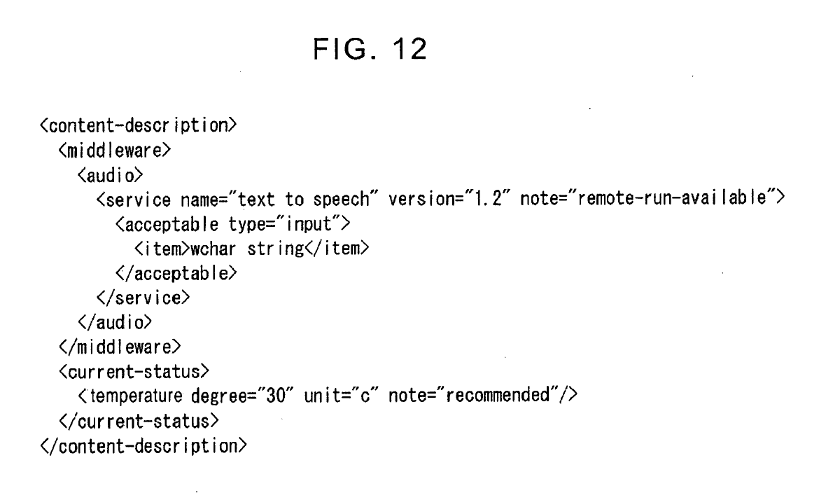

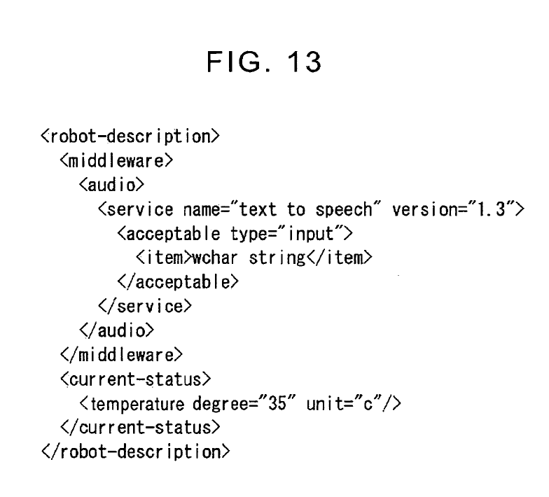

For example, if the content usage-condition information of given content is represented by a description shown in FIG. 12, nodes corresponding to the nodes indicating the content usage-condition information are detected from the description shown in FIGS. 9 to 11. The detected nodes are shown in FIG. 13.

Then, it is determined whether or not the detected QA-form nodes satisfy the conditions of the content usage-condition information nodes except if the conditions are not required (or except if the conditions are recommended).

In FIG. 12 showing the content usage-condition information, the TTS function after version 1.2 is defined as a condition, whereas, in FIG. 13 showing the robot information (i.e., the QA form), the TTS function at version 1.3 is installed. In FIG. 12, a temperature of 30° C. or more is recommended as a work environment, whereas, in FIG. 13, the temperature is 35° C. or more. In this example, therefore, this content is regarded as content that the robot 2 is permitted to use, and is added to the list.

The matching of tagged attributes is conducted to check whether each attribute is present and whether the attribute value is included. If either lacks, a false result is determined.

Referring back to FIG. 8, the server 4 combines the generated list into a SOAP envelope to generate a SOAP reply, and returns the SOAP reply to the robot 2 (step (4)). If the server 4 does not meet the request of the user 1, the SOAP reply including the reason is returned.

Upon receiving the SOAP reply from the server 4, the robot 2 analyzes the SOAP reply, and extracts the element information. The extracted element information is matched with the stored personal information (such as preference) of the user 1 to select the matched content. Then, the robot 2 requests acquisition of the selected content (step (5)). The robot 2 combines the request into a SOAP envelope, and transmits the SOAP envelope to the server 4 (step (6)).

For example, the robot 2 may present a content list submitted from the server 4 to the user 1, and may request acquisition of the content specified by the user 1.

Upon receiving the request from the robot 2, the server 4 detects a URL indicating the location of a required file (step (7)). The server 4 generates a SOAP reply including the URL, and returns the SOAP reply to the robot 2 (step (8)).

The robot 2 sends an HTTP GET request for the required file to the server 4 (step (9)). The server 4 returns the requested file to the robot 2 (step (10)), and starts downloading, for example, the dance sequence requested by the robot 2.

Upon receiving the required file, the robot 2 performs an action requested by the user using the file (step (11)).

Accordingly, content adapted to the hardware configuration or platform of the requesting robot 2 can be provided. For example, in response to a request for song data with dances, data adapted to the configuration of the robot 2, that is, dance data that the robot 2 is capable of performing and song data that the robot 2 is capable of playing back, can be selected and transmitted.

In the foregoing description, the server 4 selects content that the server 4 can provide according to a QA form submitted from the robot 2, by way of example. However, the present invention is not limited to this exemplification. Alternatively, the server 4 may transmit usage conditions of content to the robot 2, and the robot 2 may determine whether or not its capabilities meet the conditions. If the conditions are met, the robot 2 may receive the content.

If the robot 2 does not have capabilities that meet the usage conditions, the robot 2 may receive a program for acquiring the capabilities from the server 4.

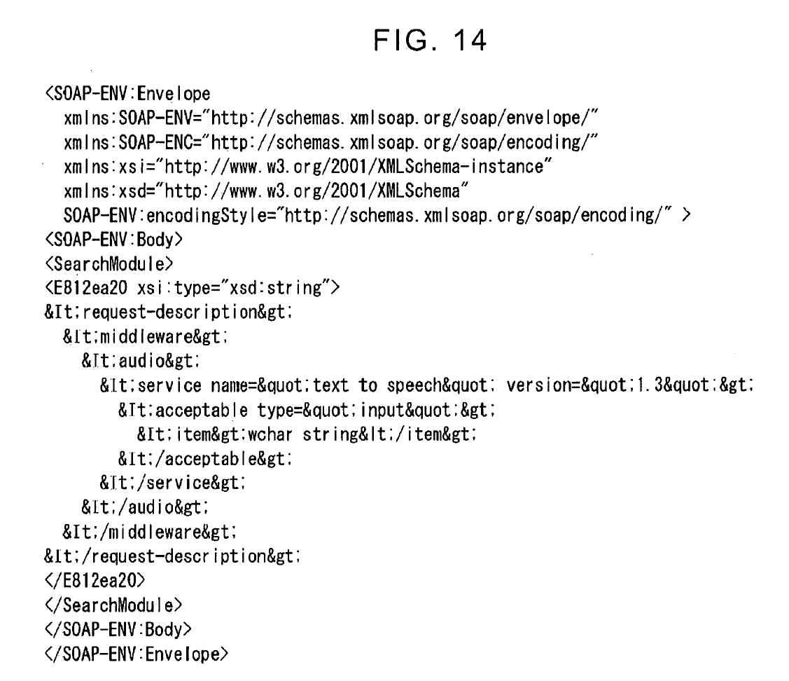

For example, it is presumed that a text-to-speech (TTS) function is required as middleware, such as a case where the robot 2 is desired to read a fairy tale to the user 1. If the robot 2 does not have the TTS function, the <request-description> shown in FIG. 14 is combined with a QA form into a SOAP envelope, and the SOAP envelope is transmitted to the server 4.

If the server 4 has a TTS module, the server notifies the robot 2 of the URL of this module. If a plurality of modules are requested, the URL of a module matched with conditions is notified.

In actually downloading a module, the server 4 determines whether the module is to be downloaded into the robot 2 or into a remote processor (not shown) for externally controlling the robot 2. If an internal memory of the robot 2 has limitations, the module is downloaded to the remote processor. The robot 2 communicates with the downloaded module via the remote processor, and uses content.

In this case, the remote processor has the following functions:
a wired LAN for establishing connection to a network;
a SOAP/XML module for combining information into a SOAP envelope and extracting the received information;
an HTTP module for communicating SOAP envelopes via HTTP;
a software module for administrating communication;
a module for matching descriptions using the XML module;
a module for resolving the dependency using the description matching;
a module for performing downloading or communication on behalf of the robot; and
a storage and database system for storing the downloaded content.

The present invention is not restrictively applied to a product called “robot”. The present invention may also be applicable to a product belonging to other industrial field, such as a toy, as long as the product is a mechanical apparatus or any other general-purpose mobile apparatus which utilizes electric or magnetic actions to perform motions which resemble motions of human beings, or a data processing system that computes data describing motions of these devices.

While SOAP-communication services in accordance with the execution environment for robots have been described, the present invention is not limited to this form. Other than SOAP communication, e.g., platform-independent remote procedure call (RPC) communication, such as XML-RPC, may be used. Software to be provided to a robot may be divided into a plurality of sites not in a single site, and a Web service to introduce a different site that associates the sites may be established.

Therefore, the disclosed embodiment of the present invention is merely illustrative, and the present invention is not to be restrictively construed. The spirit and scope of the present invention are to be understood from the appended claims.

1. A content providing system comprising a robot and a server, said robot and said server communicating with each other,
said robot comprising:
requesting means for transmitting robot information to said server and for requesting said server to provide content; and
using means for using the content provided in accordance with the request of said requesting means,
said server comprising:
detecting means for detecting content having usage conditions that are met by the robot information; and
providing means for providing the content detected by the detecting means to the robot.

2. The content providing system according to claim 1, wherein the robot information includes information about an operating system of the robot, a unique robot ID assigned to the robot, a robot-type ID assigned to the type of the robot, hardware configuration information of the robot, a function list of the robot, a database list of the robot, or work environment information of the robot.

3. The content providing system according to claim 2, wherein the usage conditions include information about an operating system required for using the content, a unique robot ID assigned to a robot that is permitted to use the content, an ID indicating the type of a robot that is permitted to use the content, a function list required or recommended for using the content, information about a robot configuration required or recommended for using the content, or information about a work environment required or recommended for using the content.

4. A content providing system including a robot and a server, said robot and said server communicating with each other,
said server comprising:
transmitting means for transmitting to said robot usage conditions of content that said server can provide; and
providing means for providing content whose usage conditions are satisfied by said robot to said robot,
said robot comprising requesting means for determining whether or not said robot satisfies the usage conditions transmitted by the transmitting means of said server, and requesting said server to provide content whose usage conditions are satisfied by said robot.
